(19) United States
(12) Patent Application Publication
(10) Pub. No.: US 2012/0266759 A1
(43) Pub. Date: Oct. 25, 2012

(54) COOLING APPARATUS, DOUGH PREPARATION APPARATUS PROVIDED WITH SUCH A COOLING APPARATUS AND METHOD FOR COOLING DOUGH PRODUCTS

(76) Inventor: Pieter Van Capelleveen, Elst (NL)

(21) Appl. No.: 13/502,169

(22) PCT Filed: Oct. 15, 2010
(86) PCT No.: PCT/NL2010/050680

§ 371 Date: Jun. 27, 2012

(30) Foreign Application Priority Data
Oct. 16, 2009 (NL) 1037404

(51) Int. Cl. F28F 27/00; A21B 1/42; F28F 9/00

(52) U.S. Cl. 99/443 R; 165/47; 165/11.1

(57) ABSTRACT

A cooling apparatus (1) for cooling dough products, for instance loaves of bread, provided with a cooling space (2) and a conveying system (T) with carriers (7), which conveying system (T) extends at least partly through the cooling space (2) in order to convey the carriers (7) with dough products (B) through the cooling space (2) for cooling the dough products, wherein the cooling apparatus (2) comprises placing means (12) for placing supplied dough products on the carriers (7) of the conveying system (T) and comprises removing means (13) for taking cooled dough products from the carriers (7) of the conveying system (T), wherein adjacent the removing means (13) of the cooling apparatus (1) a buffer cabinet (14) is provided for receiving carriers with cooled dough products from the conveying system and/or delivering carriers with cooled dough products to the conveying system. The invention further relates to a dough preparation apparatus (I) provided with such cooling apparatus and to a method for cooling dough products.

The invention relates to a cooling apparatus for cooling dough products, for instance loaves of bread, provided with a cooling space and a conveying system with carriers, which conveying system extends at least partly through the cooling space in order to convey the carriers with dough products through the cooling space for cooling the dough products, wherein the cooling apparatus comprises placing means for placing supplied dough products on the carriers of the conveying system, and comprises removing means for taking cooled dough products from the carriers of the conveying system.

Such a cooling apparatus is known from, for instance, EP 1,981,346. The known cooling apparatus comprises a conveying system which passes carriers through carrier cabinets through a cooling space in order to cool the dough products for a particular period of time in the cooling apparatus to a desired temperature. The dough products are introduced into the cooling apparatus after having been conveyed from an oven to the cooling apparatus. In the cooling apparatus, the dough products are cooled down to a temperature suitable for packaging the products. When the dough products have been sufficiently long in the cooling space and have reached the predetermined suitable temperature, the dough products are conveyed to a packaging apparatus where the cooked and cooled dough products are packaged.

When a malfunction in the packaging apparatus occurs, or when the packaging apparatus is out of order for a different reason, the dough products which come from the oven and which are thereupon cooled in the cooling apparatus, cannot be packaged. As the oven cannot simply be switched off, and hence the production flow from the oven cannot be easily stopped, a constant supply of dough products from the oven to the cooling apparatus will take place. However, the constant stream of cooled dough products cannot be fed to the packaging apparatus. As a result, there is a surplus of dough products coming from the cooling apparatus that cannot be packaged. In such a situation, this surplus of dough products is cleared from the cooling apparatus and then discharged to be used in, for instance, cattle feed. Therefore, malfunctions in the packaging apparatus are undesired in connection with an interruption of the production process and can also lead to high costs.

Therefore, the invention envisages providing a cooling apparatus, wherein a malfunction in the packaging apparatus is of less influence on the production process of the dough products.

To this end, the invention provides a cooling apparatus of the type described in the opening paragraph, wherein adjacent the removing means of the cooling apparatus, a buffer cabinet is provided for receiving carriers with cooled dough products from the conveying system and/or delivering carriers with cooled dough products to the conveying system.

As a buffer cabinet is provided adjacent the removing means of the cooling apparatus, at a standstill of the packaging apparatus due to a malfunction or a different cause, a number of dough products that should be supplied from the cooling apparatus to the packaging apparatus can be collected. As a result, depending on the construction of the buffer cabinet, a few up to many dough products, such as loaves of bread, can be collected for a period of, for instance, a few minutes to a few hours. These dough products therefore remain in the production process and need not be rejected and discharged. Such a buffer capacity cannot simply be obtained with the aid of the conveying belts which are provided between the cooling apparatus and the packaging apparatus, as to that end, considerable lengths of conveyor belts should be available.

A buffer cabinet in the cooling apparatus according to the invention also ensures that the dough products, after the standstill of the packaging apparatus has been removed, can once again simply be added to the production stream and be fed to the packaging apparatus without hindering the production stream continuing parallel thereto with dough products. The buffer cabinet can be designed for receiving a number of carriers in carrier positions, wherein the buffer cabinet is further designed for conveying carriers step by step from the conveying system to an internal space of the buffer cabinet and from a previous carrier position to a subsequent carrier position. Carriers provided with dough products which cannot be conveyed further in the direction of the packaging system are taken from the conveying system by the buffer cabinet and are received in the buffer cabinet.

To this end, the buffer cabinet can comprise a single path, wherein the single path is designed for moving carriers in a substantially upward direction when buffering the carriers and for moving the carriers in a substantially downward direction when taking the carriers from the buffer cabinet to the conveying system. The carriers are thus introduced from a lower side of the buffer cabinet into the buffer cabinet and, upon introduction of a subsequent carrier, move upwards one carrier position. When the packaging apparatus is once more operative, the carriers are moved in a downward direction to the lower side of the buffer cabinet and in this manner leave the buffer cabinet one by one to be reintroduced in an empty carrier position in the conveying system.

In another elaboration of the invention, the buffer cabinet can comprise both a single upward path and a single downward path, wherein the upward path is designed for receiving the carriers when buffering and wherein the downward path is designed for delivering the carriers to the conveying system. Such a buffer cabinet can comprise a transfer device, with the aid of which a carrier is transferable from a carrier position of the upward path to a carrier position of the downward path. With such a buffer cabinet, for instance when the malfunction is removed, the carrier can be moved directly in substantially horizontal direction from the upward path to the downward path. In a further elaboration of the invention, the carrier cabinet can comprise more than two paths, depending on the required buffer capacity. Further, several buffer cabinets can be provided in the cooling apparatus according to the invention.

In a further elaboration of the invention, the buffer cabinet can be provided upstream of the removing means. Buffering the carriers provided with the dough products can take place in the cooling space or just next to the cooling space, but before the dough products are removed from the carrier and are moved on a further conveyor belt in the direction of the packaging apparatus. In one embodiment of the invention, the cooling space can surround the entire cooling apparatus but, in another embodiment of the invention, can also surround only a part of the cooling apparatus. In the latter exemplary embodiment of the cooling apparatus, the cooling space can comprise an entrance opening for introducing the carriers into the cooling space and an exit opening for removing the carriers from the cooling space. In this embodiment, the at least one carrier cabinet may be provided adjacent the exit opening of the cooling space.

According to a further elaboration of the invention, the cooling apparatus comprises a carrier storage cabinet, which is preferably provided upstream of the placing means. Such a carrier storage cabinet is provided with empty carriers. When the packaging apparatus comes to a standstill due to a malfunction or another interruption, the buffer function of the buffer cabinet enters into operation. As a result, a number of carriers provided with cooled dough products are taken from the conveying system of the cooling apparatus and are introduced into the buffer cabinet. Then, the carrier storage cabinet supplies new carriers to the conveying system, at least to empty carrier positions, so that the closed conveying system of the cooling apparatus always maintains the same amount of carriers. Therefore, the carrier storage cabinet preferably comprises at least the same amount of carriers as the amount of carriers that can be received in the buffer cabinet.

For an accurate and effective regulation of the buffering of the carriers with cooled dough products and simultaneous delivery and discharge of empty carriers to the conveying system, the cooling apparatus according to a further elaboration of the invention can further comprise a control for at least driving the buffer cabinet and/or the carrier storage cabinet. Such a control is preferably arranged for driving the buffer cabinet and/or the carrier storage cabinet depending on a signal. This signal can for instance be a failure signal coming from an apparatus downstream of the removing means, for instance from the packaging apparatus, from the further conveying system or from another apparatus. Based on the signal, the control can drive the buffer cabinet for receiving a carrier provided with dough products from the conveying system. Through detection of an empty carrier position, the control can drive the carrier storage cabinet for delivering a carrier to this empty carrier position. When the packaging apparatus is operative again, a signal can be delivered to the carrier storage cabinet so that the carrier storage cabinet removes a carrier from the conveying system, whereby a carrier position is cleared in the conveying system, so that this carrier position, upon reaching the buffer cabinet, can be provided with a carrier with dough products from the buffer cabinet. Naturally, the control can further be designed to drive the conveying system and/or the separate carrier cabinets in the cooling space of the cooling apparatus.

The invention further relates to a dough preparation apparatus provided with an above-described cooling apparatus, wherein the dough preparation apparatus further comprises an oven which is provided upstream of the cooling apparatus and a packaging apparatus which is provided downstream of the cooling apparatus.

The invention also relates to a method for cooling dough products, wherein the method comprises:
conveying dough products through a cooling apparatus, preferably an above-described cooling apparatus, at least through a cooling space of the cooling apparatus, over a conveying system in order to cool the dough products,
delivering the cooled dough products from the conveying system to a downstream provided further conveying system which leads to a packaging apparatus,
   characterized in that the method further comprises:
buffering carriers provided with cooled dough products adjacent the removing means of the cooling apparatus, wherein buffering is carried out with the aid of a buffer cabinet.

Such a dough preparation apparatus and such a method offer advantages and effects similar to those described for the cooling apparatus.

Further elaborations of the invention are described in the subclaims and will be further elucidated in the following, with reference to the drawings.

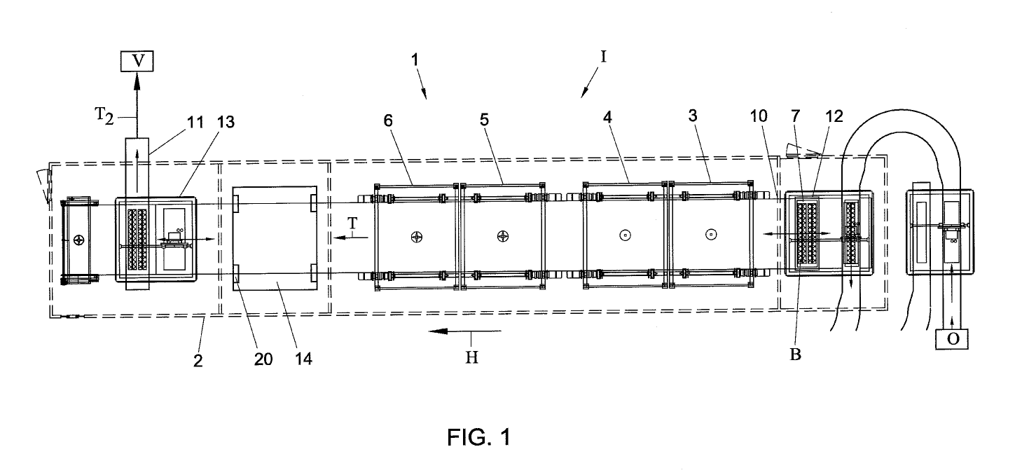

FIG. 1 shows a schematic top plan view of a cooling apparatus according to an embodiment of the invention;

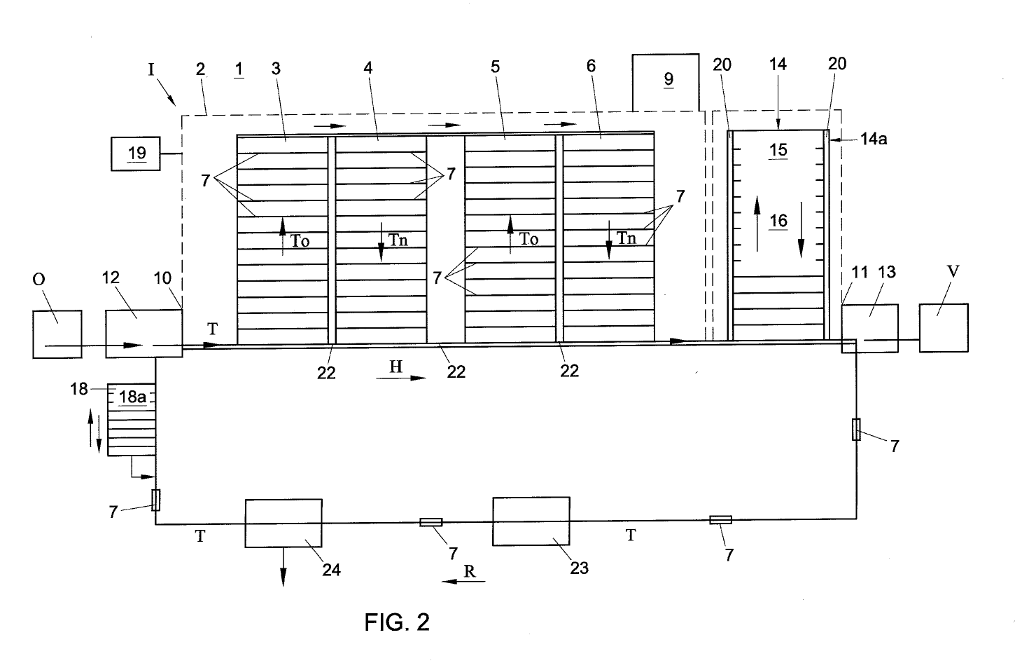

FIG. 2 shows a schematic overview of a cooling apparatus according to the invention;

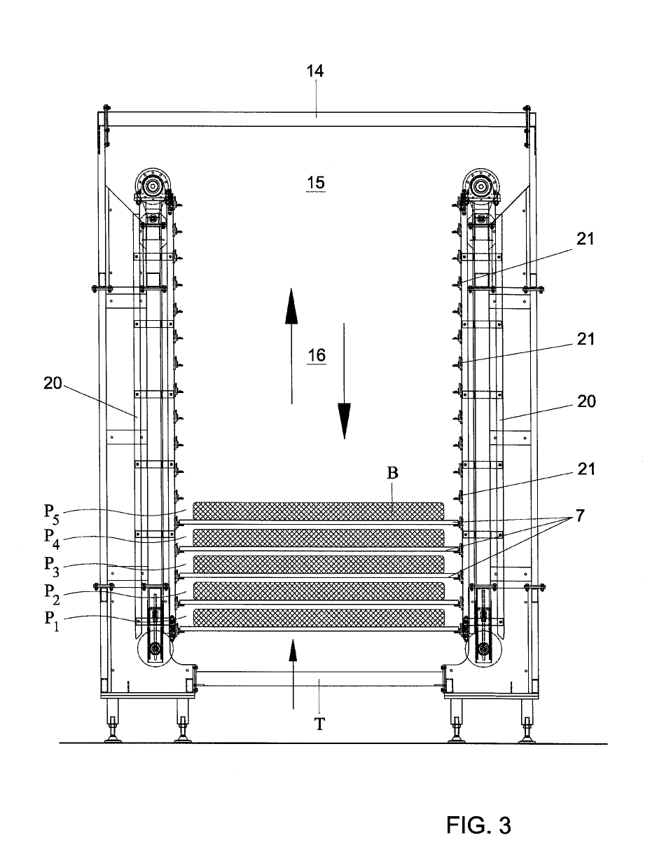

FIG. 3 shows a schematic front view of a buffer cabinet according to a first exemplary embodiment of the invention; and

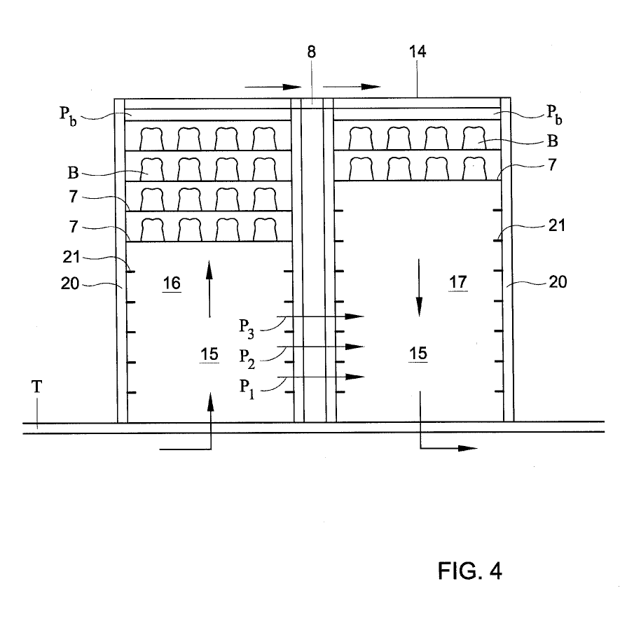

FIG. 4 shows a schematic side view of a buffer cabinet according to a second exemplary embodiment of the invention.

In the different Figures, identical reference numerals refer to identical parts.

FIG. 1 shows a top plan view of a cooling apparatus 1 according to the invention. Such a cooling apparatus 1 can form part of a dough preparation apparatus I (see also for instance FIG. 2) for dough products B. In such a dough preparation apparatus I at least one oven O is provided upstream of the cooling apparatus 1. Further, in such a dough preparation apparatus I, downstream of the cooling apparatus 1, a packaging apparatus V is provided.

The cooling apparatus 1 further comprises a cooling space 2 with at least one carrier cabinet 3, 4, 5, 6. In this exemplary embodiment, the cooling space comprises four carrier cabinets 3, 4, 5, 6. In another exemplary embodiment, the cooling apparatus can also comprise two carrier cabinets or more than four carrier cabinets, or other types of carrier cabinets. The cooling apparatus 1 is further provided with a conveying system T with carriers 7, for instance wire grates. The conveying system T ensures that the carriers 7 are conveyable through the cooling apparatus 1. The conveying system T conveys a large number of carriers 7 intermittently from carrier position to carrier position. In the cooling apparatus 1 a large number of carrier positions are present so that a large number of carriers 7 and hence dough products B can be simultaneously subjected to the cooling process.

Further, cooling means 9 (see FIG. 2) are present in the cooling space 2 for cooling the air, so that the dough products B can transfer their heat to this cooler air, whereby the temperature of the dough products B decreases.

In FIG. 2, it is clearly visible that the conveying system T comprises a forward path H, which proceeds in the direction of the arrow H, and wherein this path part passes the carriers 7 through the at least one carrier cabinet 3, 4, 5, 6. The conveying system T further comprises a return path R, so that the carriers are conveyed through the cooling apparatus 1 in a closed circuit. Hence, the carriers are used only within the cooling apparatus 1 and not in other apparatuses within the dough preparation apparatus I of dough products B. It is also clearly visible that the conveying system T conveys a large number of carriers 7 through the different carrier cabinets 3, 4, 5, 6. The separate carrier cabinets 3, 4, 5, 6 can comprise a large number of carriers 7 simultaneously and thus, a large number of dough products B can be cooled simultaneously too.

In the exemplary embodiment shown, the cooling space 2 is provided with an entrance opening 10 for introducing dough products B into the cooling space 2 and with an exit opening 11 for removing the dough products B from the cooling space. After baking the dough products B in the oven O, these are to be cooled in order to enable packaging thereof. As the cooling apparatus 1 comprises a closed cooling space 2, it is necessary that the dough products B can be introduced into the cooling apparatus and be removed again. Preferably, these openings are no larger than necessary for introducing a carrier 7 with dough products B.

In another exemplary embodiment of the cooling apparatus according to the invention (not shown), the cooling space can surround the entire cooling apparatus. The cooling space can be a space, for instance a conditioned space, in which all parts of the cooling apparatus are placed.

From the oven O, the dough products B are lifted via for instance placing means 12 from the baking tins or from the baking tray to then be placed on a carrier 7. The carrier 7 is loaded in a manner so that as many dough products B as possible sit thereon but so that, simultaneously, also sufficient air can keep flowing between the dough products for enabling a good heat exchange between the hot dough products B and the much cooler air.

After the dough products B have cooled, they are removed at the end of a cooling path, the forward path H, from the carriers 7 by for instance removing means 13. The dough products B are then conveyed with the aid of a further conveying system T2 to the packaging apparatus V.

The cooling apparatus 1 according to the invention further comprises at least one buffer cabinet 14. This buffer cabinet 14 is preferably placed downstream from the carrier cabinets 3, 4, 5, 6 of the cooling apparatus 1 and upstream of the removing means 13. The forward path H of the conveying system T extends under the buffer cabinet 14. The buffer cabinet 14 is designed for taking carriers 7 with already cooled dough products B from the conveying system T and reintroducing them into the conveying system T again.

When the packaging apparatus V is not in operation due to, for instance, a malfunction, no dough products B can be discharged from the cooling apparatus 1 to the packaging apparatus V. However, as the production of dough products B from the oven O cannot be stopped just like that, the dough products B that leave the cooling apparatus at the exit opening 11 are collected, removed from the production process and discharged to be used in, for instance, the preparation of cattle feed. What can be prevented through the use of the buffer cabinet 14 is that numbers of dough products B leave the production process when the packaging apparatus V breaks down. The buffer cabinet 14 is designed (see also FIG. 3) for receiving a number of carriers 7 in carrier positions P1, P2, P3, P4, P5. When the packaging apparatus V breaks down and the control 19 receives a signal that the second conveying system T2 is stopped, the buffer cabinet 14 is driven for receiving a carrier 7 from the conveying system T. The buffer cabinet 14 will engage the carrier 7, which at that moment is located under the buffer cabinet 14, and move this carrier 7 to the internal space 15 of the buffer cabinet 14 to the lower carrier position P1. In the embodiment shown in FIG. 3, the buffer cabinet 14 comprises a single path 16, while the carriers can be moved along the single path 16 in upward and downward direction. The buffer cabinet 14 is provided with two chain conveyors 20 with carrier guides 21. The chain conveyors 20 can be driven in steps. In the periods of standstill between the steps, carriers 7 can be introduced into the buffer cabinet 14 or be delivered from the buffer cabinet 14 to the conveying system T. When a subsequent carrier 7 is included, the previous carrier 7 will move in an upward direction along the single path 16 from the first carrier position P1 to the second carrier position P2. The following carrier 7 is then taken from the conveying system T and brought to the first carrier position P1. In this manner, the buffer cabinet 14 can bridge a malfunction from a few minutes to a few hours, by buffering the carriers 7 with dough products B which have cooled during this period of time. These dough products B are reintroduced at a later stage into the production process so that at a later moment in time they can still be conveyed to the packaging apparatus V and be packaged. When the malfunction in the packaging apparatus V is removed, the carriers 7 can be reintroduced one by one in a downward direction along the path 16 to the conveying system for conveying them to the packaging apparatus V.

When the buffer cabinet 14 takes up the carriers 7 from the conveying system T, this results in empty carrier positions in the conveying system T. Accordingly, it is very advantageous when further down in the conveying system T, a carrier storage cabinet 18 is included in the conveying system T. The carrier storage cabinet 18 can for instance be provided upstream of the cooling space 2, along the conveying system T. Preferably, the carrier storage cabinet 18 is placed upstream of the placing means 12, along the conveying system T. The carrier storage cabinet 18 comprises a number of empty carriers 7. When an empty carrier position is noticed in the conveying system T, the carrier storage cabinet 18 places a carrier 7 from the internal space 18a of the carrier storage cabinet 18 in the conveying system T at that empty position. As a result, during a malfunction of the packaging apparatus V, the placing means can simply continue placing dough products B coming from the oven O on successive carriers 7 of the conveying system T.

When the packaging apparatus V is in operation again and the carriers 7 of the buffer cabinet 14 are to be reintroduced into the conveying system T, the carrier storage cabinet 18 is driven by the control such that it occasionally takes a carrier 7 from the conveying system T. The thus created empty carrier position then passes the placing means 12, the carrier cabinets 3, 4, 5, 6 and when it arrives at the buffer cabinet 14 this will place a carrier 7 with dough products B in this empty carrier position. The control 19 is designed such that it can drive the buffering process by driving the buffer cabinet 14 and the carrier storage cabinet 18. The control 19 can further be coupled to, inter alia, sensors for detecting empty carrier positions, detecting a standstill of the packaging apparatus V and detecting the speed of the second conveying system T2. Naturally, the control 19 can also be designed for driving the different carrier cabinets 3, 4, 5, 6 in the cooling space 2. For cooling the dough products B coming from the oven O, the carriers 7 provided with loaves of bread travel a path through the carrier cabinets 3, 4, 5, 6 in the cooling space 2 depending on the type and size of the loaves of bread B. For instance, one type of bread can travel a longer path in that it is passed through four carrier cabinets 3, 4, 5, 6 and another type of bread only through two carrier cabinets 3, 5 so that for the last type of bread, the total cooling time is considerably shorter.

The forward path H of the conveying system T comprises in the cooling space 2 at least one upward path To in a carrier cabinet 3, 5 and at least one downward path Tn in a subsequent carrier cabinet 4, 6. Through the use of upward To en downward Tn paths, relatively many carriers 7 with many dough products B can remain in the cooling space 2 simultaneously.

A conveyor 22 can extend below the carrier cabinets 3, 4, 5, 6 to the exit opening 11 of the cooling space 2, such that, if desired, a carrier 7 can be conveyable directly from the entrance opening 10 to the exit opening 11. This may be practical for instance when the dough products B need hardly any cooling or only very brief cooling.

The control 19 can further be designed to set the route of the carriers 7 through the cooling apparatus 1 depending on the type of dough products B or the dough products size. As a result, the carrier 7 can travel different routes as described hereinabove. It is important that the routes of the different carriers are set well, since it is of importance that the hot dough products B, having a temperature of approximately 110° C., cool down sufficiently, to approximately 20° C. The fact is that too high a temperature at packaging can lead to formation of condensation in the package so that the dough products B can become soft. After the loaves of bread B have been removed from the carriers 7, the carriers 7 continue their route by being conveyed back via the return path R to the entrance opening 11, where, by the placing means 12, new loaves of bread or other dough products B such as, for instance, cakes or small buns are placed on the carriers 7.

On the return path R of the conveying system T a cleaning unit 23 can be provided for cleaning the carriers 7 just used. The return path R can further also comprise a carrier exchange station 24. This carrier exchange station 17 enables removal during use of the cooling apparatus of any malfunctioning carriers 7 or replacement thereof by other carriers 7. Also a carrier 7 which is not sufficiently clean upon leaving the cleaning unit 23 can be removed.

In FIG. 4, a schematic side view of a second embodiment of a buffer cabinet 14 according to the invention is shown. In the second embodiment, the buffer cabinet 14 comprises a separate upward path 16 and a separate downward path 17. Adjacent the top of the upward 16 and the downward 17 path, a transfer device 8 is provided with the aid of which a carrier 7 which is located in the top carrier position Pb of the upward path 16 is movable to the top carrier position Pb of the downward path 17. The transfer device 8 can comprise a chain extending in horizontal direction (not shown) provided with at least one collapsible pusher cam (not shown). Between the two upper carrier positions Pb mentioned, guides may be provided over which a carrier 7 is slideable with the aid of the pusher cam. In another exemplary embodiment of the carrier cabinet, the transfer device 8 can be designed for transferring a carrier from any random carrier position P1, P2, P3, . . . of the upward path 16 to a carrier position P1, P2, P3, . . . provided at the same horizontal height of the downward path 17. This is particularly favourable when the buffer cabinet is not completely filled when the carriers are delivered to the conveying system T again.

It is clear that the invention is not limited to the described exemplary embodiment but that various modifications within the framework of the invention as defined in the claims are possible. Naturally, the cooling apparatus 1 according to the invention can be used for cooling all sorts of dough products, such as, for instance, French bread, cakes, current loaves, buns etc. The cooling space 2 can also be provided with other types of carrier cabinets 3, 4, 5, 6, so that the dough products B to be cooled can travel other paths through the cooling space. Further, the dough preparation apparatus I can also be provided with a cutting device which may be provided between the removing means 13 and the packaging apparatus V. Further, several buffer cabinets 14 and/or several carrier storage cabinets 18 can be provided in the cooling apparatus 1, depending on the desired buffer capacity of the system. It is preferred that the carrier storage cabinet 18 can be placed at different locations along the return path R of the conveying system T. Finally, the buffer cabinet may be provided in the cooling space 2 or downstream of the cooling space 2, while it is possible that the buffer cabinet 14 is provided in a separate conditioned space, while, at the same time, the exit opening 11 of the cooling space forms the entrance opening of the separate space.

1. A cooling apparatus for cooling dough products, for instance loaves of bread, provided with a cooling space and a conveying system with carriers, which conveying system extends at least partly through the cooling space in order to convey the carriers with dough products through the cooling space for cooling the dough products, wherein the cooling apparatus comprises placing means for placing supplied dough products on the carriers of the conveying system, and comprises removing means for taking cooled dough products from the carriers of the conveying system, characterized in that adjacent the removing means of the cooling apparatus, a buffer cabinet is provided for receiving carriers with cooled dough products from the conveying system and/or delivering carriers with cooled dough products to the conveying system.

2. A cooling apparatus according to claim 1, wherein the cooling apparatus comprises a forward path, which extends substantially from the placing means to the removing means and passes the carriers through the at least one cooling space, wherein the conveying system comprises a return path which returns the carriers substantially from the removing means back to the placing means of the cooling apparatus.

3. A cooling apparatus according to claim 1, wherein the forward path and the return path together form a closed circuit.

4. A cooling apparatus according to claim 1, wherein the buffer cabinet is designed for receiving a number of carriers in carrier positions, wherein the buffer cabinet is designed for conveying carriers stepwise from the conveying system to an internal space of the buffer cabinet and from a previous carrier position to a subsequent carrier position.

5. A cooling apparatus according to claim 1, wherein the buffer cabinet comprises a single path wherein the single path is designed for moving carriers in a substantially upward direction when buffering the carriers and for moving carriers in a substantially downward direction when taking the carriers from the buffer cabinet to the conveying system.

6. A cooling apparatus according to claim 1, wherein the buffer cabinet comprises both a single upward path and a single downward path wherein the upward path is designed for receiving the carriers when buffering and wherein the downward path is designed for delivering the carriers to the conveying system.

7. A cooling apparatus according to claim 6, wherein the buffer cabinet comprises a transfer device with the aid of which a carrier is transferable from a carrier position of the upward path to a carrier position of the downward path.

8. A cooling apparatus according to claim 1, wherein the buffer cabinet is provided upstream of the removing means.

9. A cooling apparatus according to claim 1, wherein the cooling apparatus comprises a carrier storage cabinet which is preferably provided upstream of the placing means.

10. A cooling apparatus according to claim 1, wherein the cooling apparatus comprises a control for at least driving the buffer cabinet and/or the carrier storage cabinet.

11. A cooling apparatus according to claim 10, wherein the control is designed for driving at least the buffer cabinet and/or the carrier storage cabinet depending on a signal, for instance a failure signal coming from an apparatus downstream of the removing means.

12. A dough preparation apparatus provided with a cooling apparatus according to claim 1, wherein the dough preparation apparatus further comprises an oven which is provided upstream of the cooling apparatus and a packaging apparatus which is provided downstream of the cooling apparatus.

13. A method for cooling dough products, wherein the method comprises:
conveying dough products through a cooling apparatus, at least through a cooling space of the cooling apparatus, over a conveying system in order to cool the dough products,
delivering the cooled dough products from the conveying system to a downstream provided further conveying system which leads to a packaging apparatus,
characterized in that the method further comprises:
buffering carriers provided with cooled dough products adjacent the removing means of the cooling apparatus, wherein buffering is carried out with the aid of a buffer cabinet.

14. A method according to claim 13, wherein during buffering, the carriers provided with the dough products are taken from the conveying system and are received in the buffer cabinet and wherein the carriers are delivered from the buffer cabinet to the conveying system when the buffer capacity is no longer required.

15. A method according to claim 14, wherein upstream of the placing means a carrier storage cabinet is provided, which adds carriers to the conveying system when the buffer cabinet receives carriers from the conveying system and wherein the carrier storage cabinet receives carriers from the conveying system when the buffer cabinet delivers carriers to the conveying system.
